(19) United States
(12) Patent Application Publication
(10) Pub. No.: US 2016/0214657 A1
(43) Pub. Date: Jul. 28, 2016

(54) CARGO BED EXTENSION

(71) Applicant: Ford Global Technologies, LLC, Dearborn, MI (US)

(72) Inventors: Frank Joseph Topolovec, Canton, MI (US); Heather L. Knechtges, Saline, MI (US); Dennis Michael Harrigan, Monroe, MI (US)

(21) Appl. No.: 14/607,466

(22) Filed: Jan. 28, 2015

(51) Int. Cl. B62D 33/027; B62D 33/037

(52) U.S. Cl. CPC B62D 33/027; B62D 33/037

(57) ABSTRACT

A vehicle includes a cargo bed extension having a base that is operable to translate relative to, and stow beneath a vehicle cargo bed. The cargo bed extension also includes a pair of opposing secondary sidewalls extending from the base that are adapted to latch to opposing sides of the cargo bed. The cargo bed extension further includes a tailgate pivotally coupled to the base and capable of selectively retaining to the cargo bed when the base is stowed. The tailgate is further capable of retaining to the secondary sidewalls when the base is extended.

### TECHNICAL FIELD

The present disclosure relates to cargo bed extensions for vehicles.

### BACKGROUND

Vehicles are commonly used to transport materials. Some vehicles are designed to include a bed, or cargo hold, to transport the materials. Designers of such cargo areas may balance tradeoffs between the capacity of the cargo hold and the overall length of the vehicle. A larger cargo hold typically results in a longer vehicle, and at the same time it may be desirable to limit the width and height of the vehicle based upon other factors. Additionally, extended length vehicles can be less maneuverable during driving.

Certain cargo area extenders require additional components to increase cargo capacity. The added components can be cumbersome to implement by a user and commonly must be stored in the cargo area consuming storage volume when not in use.

### SUMMARY

In at least one embodiment, a vehicle includes a main cargo bed including a floor and a first pair of opposed sidewalls extending from either side of the floor. The vehicle also includes an extension assembly having a base that is slidable relative to the main cargo bed and defines a stowed position that is substantially flat against the floor. The extension assembly includes a second pair of opposed sidewalls rotatably extending from the base. The vehicle further includes a tailgate pivotally coupled to the base.

In at least one embodiment, a vehicle includes a vehicle cargo bed including a floor and a first pair of opposed sidewalls extending from the floor. The vehicle also includes an extension assembly that is moveable with respect to the vehicle cargo bed. The extension assembly includes a base and a second pair of opposed sidewalls rotatably attached to the base. Each of the second pair of sidewalls is capable of retaining to one of the first pair of opposed sidewalls. The vehicle further includes a tailgate rotatably disposed on the base and cooperable with the second pair of opposed sidewalls. The extension assembly is movable to an extended position where the base is aligned with the bed floor forming an extended floor and the first pair of opposed sidewalls are aligned with the second pair of opposed sidewalls forming an extended pair of opposed sidewalls. The tailgate is capable of latching to the extended pair of opposed sidewalls in the extended position. The extension is further movable to a stowed position where the second pair of opposed sidewalls are superposed over the base and the extension assembly overlaps the floor.

In at least one embodiment, a cargo bed extension includes a base operable to translate relative to, and stow against a vehicle cargo bed. The cargo bed extension also includes a pair of opposing secondary sidewalls extending from the base that are adapted to latch to an opposing side of the cargo bed. The cargo bed extension further includes a tailgate pivotally coupled to the base and capable of selectively retaining to the cargo bed when the base is stowed. The tailgate is further capable of retaining to the secondary sidewalls when the base is extended.

### BRIEF DESCRIPTION OF THE DRAWINGS

FIG. 1 is a perspective view of a vehicle cargo bed with an extension assembly.

FIG. 2 is a perspective view of the vehicle of FIG. 1 with a tailgate in an open position and the extension assembly stowed.

FIG. 3 is a perspective view of the vehicle of FIG. 1 with the tailgate in an open position and the extension assembly extended.

FIG. 4 is a perspective view of the vehicle of FIG. 1 with the tailgate in a closed position and the extension assembly extended.

FIG. 5 is an overhead view of a vehicle cargo area with an extension assembly in an extended position.

FIG. 6 is a perspective view of a vehicle cargo bed with a unitary extension assembly.

FIG. 7 is a cross-sectional view along line 7-7 of FIG. 6 depicting the unitary extension assembly in a stowed position.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

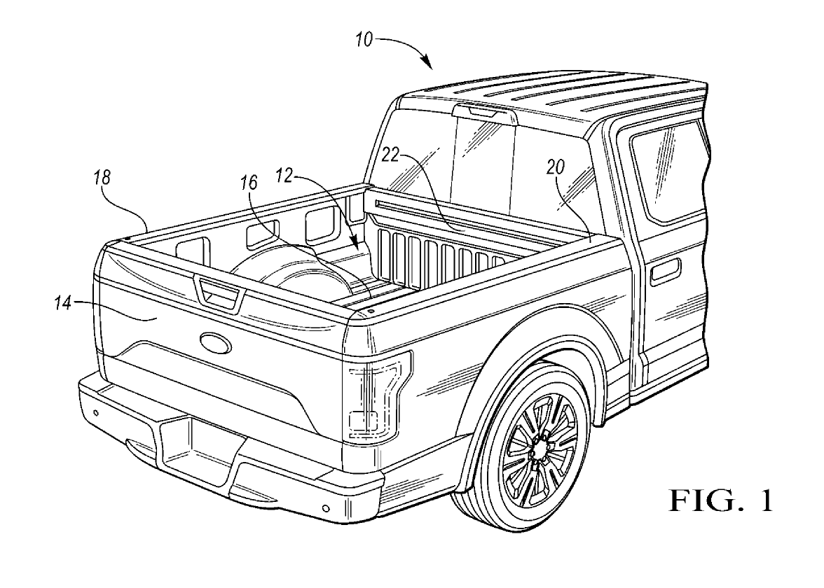

Referring to FIG. 1, a vehicle 10 includes a vehicle cargo bed 12. The cargo bed 12 has a tailgate 14 to allow access to cargo stored on a bed floor 16. The tailgate 14 is shown in a closed position. A pair of opposed sidewalls include a left sidewall 18 and a right sidewall 20 that extend vertically from the bed floor 16. An end wall 22 also extends vertically from the bed floor 16, connecting the pair of opposed side walls. The combination of sidewalls and end wall retain objects laterally within the cargo bed 12.

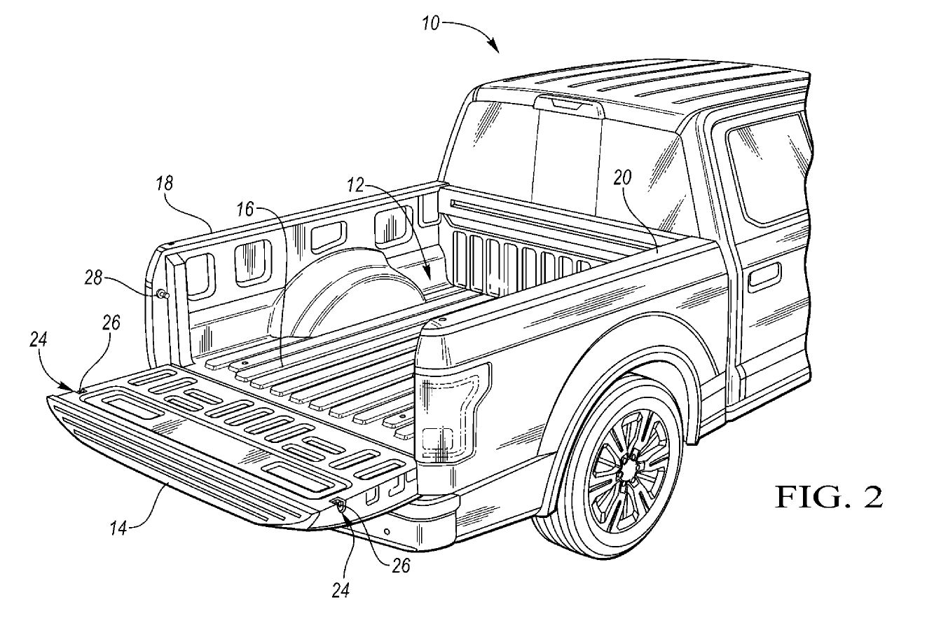

Referring to FIG. 2, the tailgate 14 is articulable and provides access to the cargo stored in the cargo bed 12. The tailgate 14 is shown in FIG. 2 in the open position. The tailgate 14, as shown, includes at least one primary retaining member 24 in order to secure the tailgate 14 to the cargo bed 12. In at least one embodiment, the tailgate 14 may include a primary catch 26. Each sidewall 18, 20 may include a corresponding primary post 28. The primary catch 26 and primary post 28 latch together to form a secure connection between the tailgate 14 and the cargo bed 12. Retaining members on opposing sides may help ensure stability of the tailgate in the closed position, thereby retaining cargo within the cargo bed.

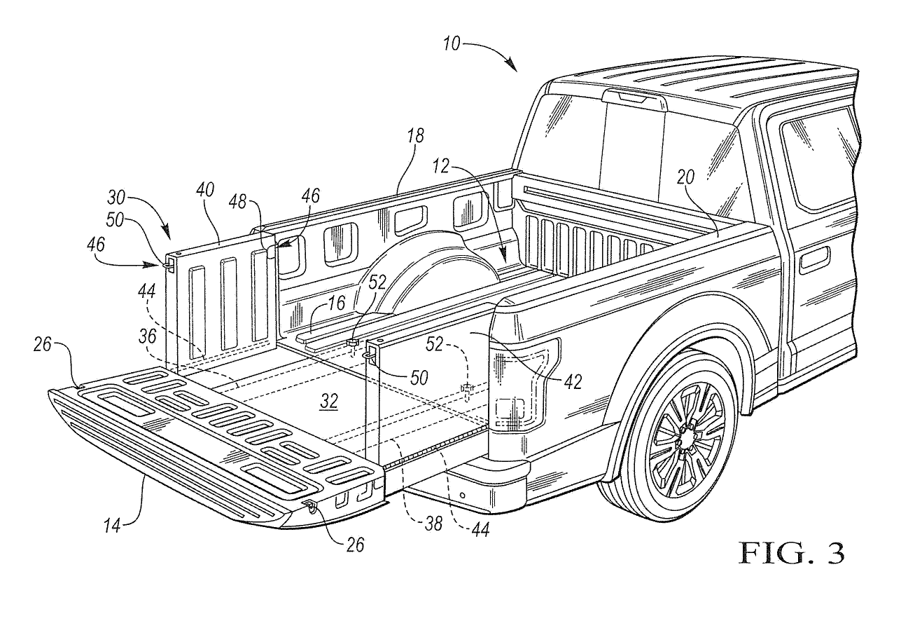

Referring to FIG. 3, the vehicle 10 includes an extension assembly 30 between the tailgate 14 and cargo bed 12. The extension assembly 30 has a base 32 that defines an extended position protruding from the bed as shown in FIG. 3. The base 32 may be aligned with the bed floor 16 in the extended position to provide an extended bed floor to accommodate longer cargo. The base 32 is slidable relative to the bed floor 16 and defines a stowed position when positioned the base 32 and the bed floor 16 are overlapped with respect to each other as shown in FIG. 2. In at least one embodiment, the base 32 is configured to slide above the bed floor 16 in the stowed position to achieve a substantially flat cargo floor. In alternative embodiments, the base may be slidably positioned beneath the bed floor in the stowed position.

The base 32 is operable to slide relative to the bed floor 16 to the stowed position using roller tracks or other sliding mechanisms. In at least one embodiment, a left roller track 36 and a right roller track 38 provides for fore and aft movement of the base 32. A user may selectively slide the base between the stowed position and the extended position on the roller tracks 36, 38. When the extension assembly 30 is extended, it effectively increases the available cargo area for transporting materials. At times when a user does not require the additional space, the extension assembly 30 may be conveniently stowed by sliding forward to overlap the cargo bed 12. The cargo space may be expanded when more cargo area is required, and reduced when necessary for a more compact vehicle size. For example, standard length eight-foot construction material would not typically fit in a six-foot cargo bed. However, an extension assembly according to the present disclosure may for example, allow a user to lengthen a six-foot cargo bed to an eight foot length to allow standard length eight-foot cargo to rest relatively flatly against the bed floor.

Extending from the base 32 is a left secondary sidewall 40 and a right secondary sidewall 42. The secondary sidewalls 40, 42 may be articulable between a horizontal position and an upright position. For example, FIG. 3 depicts the secondary side walls 40, 42 in an upright position. In a horizontal position, the secondary sidewalls 40, 42 superpose over the base 32 for stowage beneath the bed floor 16. In at least one embodiment the extension assembly 30 includes hinges 44 to allow the secondary sidewalls 40, 42 to rotate relative to the base 32. While depicted as simple hinges, alternative hinge configurations could provide more complex articulation, enhancing utility. When rotated to the horizontal position, the secondary sidewalls 40, 42 can be stowed along with the base overlapping the bed floor 16 as shown in FIG. 1. In at least one embodiment the extension assembly travels along the roller tracks 36, 38 above the cargo bed 12. In further embodiments the stowed position may allow the extension assembly 30 to nest within a port beneath the cargo bed 12.

In the vertical position, the secondary sidewalls 40, 42 are operable to combine with cargo bed's pair of opposed sidewalls 18, 20 to provide extended sidewalls. The left sidewall 40 and the right sidewall 42 may be secured to the left sidewall 18 and right sidewall 20, respectively, of the cargo bed 12. The left sidewall 40 and right secondary sidewall 42 may include secondary retaining members 46 arranged to retain the secondary sidewalls 40, 42 to primary retaining members 24 located on the cargo bed 12. In at least one embodiment, the secondary retaining members 46 include a secondary catch 48 at a forward portion of each of the secondary sidewalls 40, 42. Each secondary catch 48 latches with a primary post 28 to secure each respective secondary sidewall to the main cargo bed. In alternative embodiments, a simple hook or other fixed receiving feature may retain the secondary sidewalls to the main cargo bed.

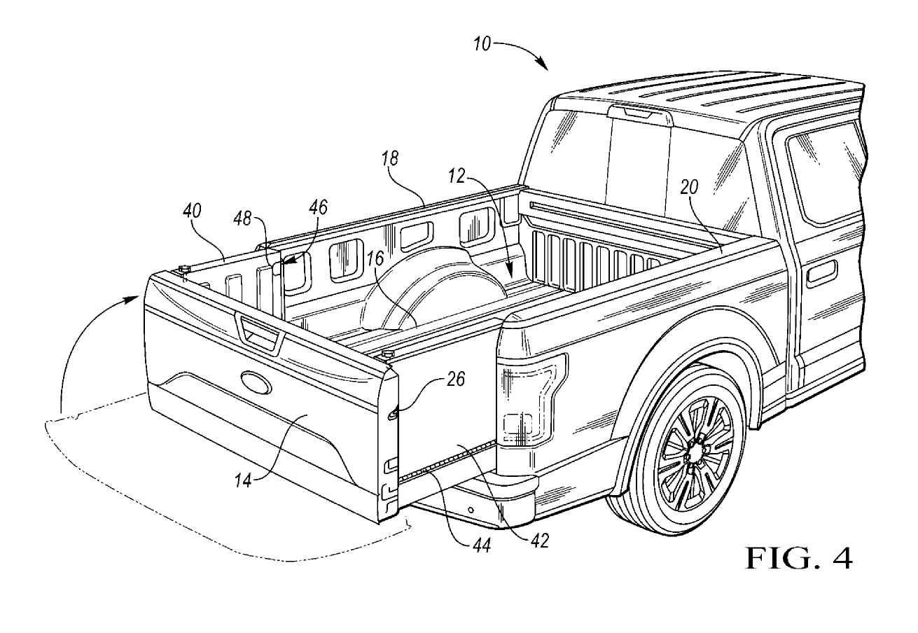

Referring to FIGS. 3 and 4, the secondary retaining members 46 may also include a secondary post 50 at a rearward portion of each of the secondary sidewalls 40, 42. Each of the secondary posts 50 may be arranged to latch with a primary catch 26 disposed on the tailgate 14. As discussed above, alternative embodiments may substitute a latch and catch system with a simple, non-articulating fixed retention mechanism. Mechanisms such as snaps, hooks, bolts, or other retainers may also be suitable.

One advantage of the configuration, as shown in FIGS. 1 and 2, allows the tailgate 14 to selectively retain to the cargo bed 12 when the base 32 is in a stowed position. The configuration, as shown in FIGS. 3 and 4, also allows the tailgate 14 to selectively retain to the secondary sidewalls 40, 42 when the base 32 is in an extended position. Since the tailgate 14 is pivotally coupled to the base 32, the same tailgate 14 is operable to retain cargo when the extension assembly 30 is in either the stowed or extended position. Further, the articulation of the extension assembly 30 avoids the need for removal of heavy components by a user when changing between the extended and stowed positions.

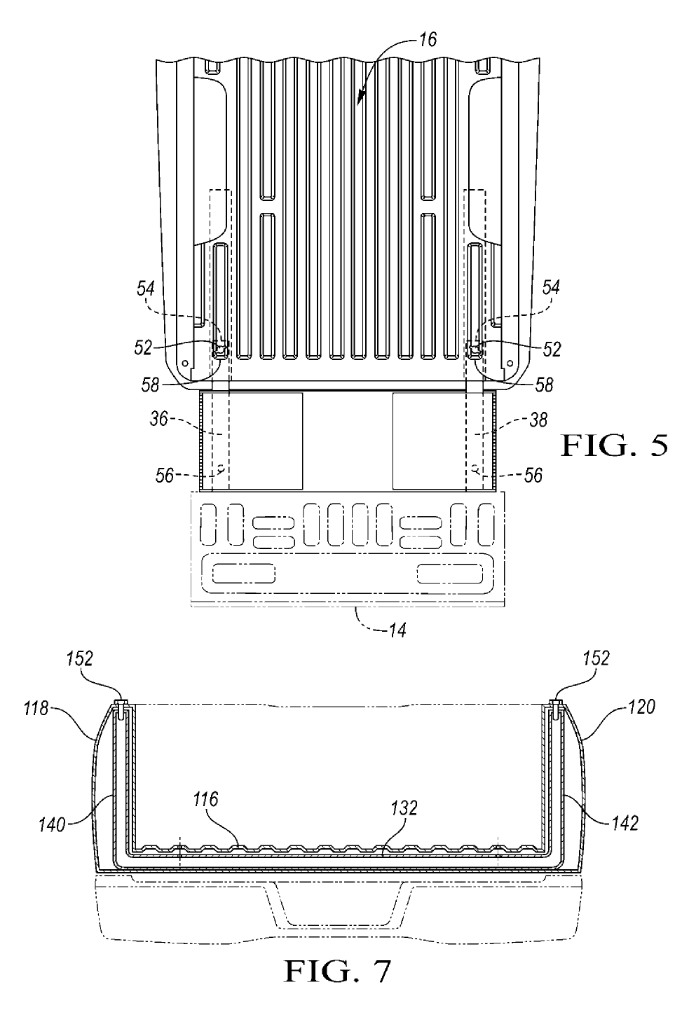

Referring now to FIG. 5, the extension assembly 30 may include a left roller track 36 and a right roller track 38 to facilitate the base transitioning between the stowed position and the extended position. The roller tracks 36, 38 may include friction reduction elements such as wheels to reduce effort required to slide the extension assembly from the stowed to the extended position or vice versa. In alternative embodiments, other combinations of friction reducing elements may be used such as a polymer slide blocks, interlocked channel tracks, roller-bearings, or multilayer tracks. Additionally, the tracks 36, 38 may include detents at set positions to urge the base 32 to one or more predetermined travel positions. Further, stops may be included at desired extremes to limit travel, for example, at fully extended or fully stowed positions.

Still referring to FIG. 5, a lock pin 52 may be applied to prevent movement of the base 32 in either the stowed or extended position. The lock pin 52 may be a pin that mates with matching holes to prevent movement of the base in the stowed and extended position, respectively. In at least one embodiment, a pair of holes 54 are located near a rear portion the bed floor 16 and allow lock pins 52 to protrude therethrough. Additionally, multiple sets of holes may be positioned along the roller tracks according to desired stop positions. As depicted in the illustrative embodiment of FIG. 5, the roller tracks 36, 38 include stowed position lock holes 56 and extended position lock holes 58. When any of the position locking holes of the roller tracks 36, 38 align with the holes 54 of the bed floor 16, the lock pins 52 may be inserted through the aligned holes. In this way, the lock pins 52 may seize movement of the roller tracks 36, 38, and correspondingly prevent the base 32 from sliding. Any number of predetermined lock positions may be suitable according to various intended uses of the extension assembly.

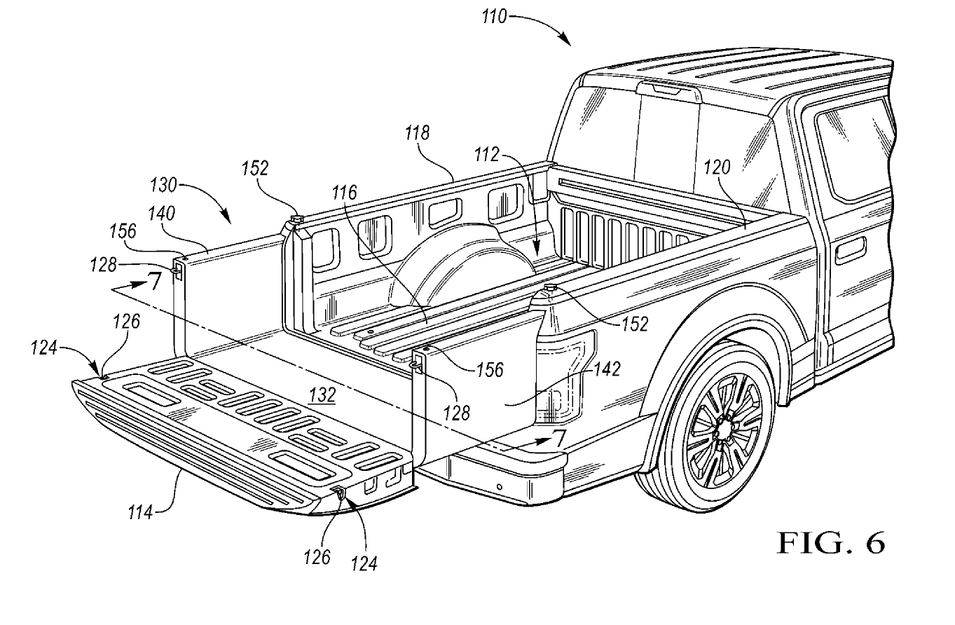

Referring now to FIGS. 6 and 7, an alternate embodiment extension assembly is depicted. Similar numbering convention is applied according to previous embodiments where applicable. A vehicle 110 may have a cargo bed 112 towards a rear portion. An extension assembly 130 allows a user to selectively increase the storage capacity of the cargo bed 112. The extension assembly 130 includes a unitary member 132. The unitary extension stows in a forward position to overlap the vehicle cargo bed 112.

The unitary member 132 may include a fixed left extension sidewall 140 and a fixed right extension sidewall 142. The extension sidewalls 140, 142 are arranged to remain in an upright position both when the extension assembly is stowed and extended. A lower portion of the unitary member is arranged to translate longitudinally between an extended position rearward of a bed floor 116 and a stowed position overlapping the bed floor 116. In at least one embodiment, the extension sidewalls 140, 142 are arranged to translate longitudinally and stow within an inner cavity of left side wall 118 and a right sidewall 120 of the vehicle cargo bed 112, respectively. In alternative embodiments, the extension sidewalls 140, 142 may be arranged to slide along an exterior surface of each of the extension sidewalls 140, 142.

This configuration eliminates the need for hinges on the sidewalls of the extension assembly 130, yet allows similar functionality relative to previous embodiments. In the extended position, the extension sidewalls 140, 142 in combination with the pair of opposed sidewalls 118, 120 form an extended vehicle cargo bed to accommodate longer cargo.

A tailgate 114 is pivotally coupled to the unitary member 132. The tailgate 114 may include primary retaining members 124 to secure the tailgate in a vertical position to the unitary member 132. The tailgate 114, as shown, includes a primary catch 126 arranged to latch to a primary post 128 located on each of the extension sidewalls 140, 142. A latch disposed on either side of the tailgate 114 may be used to distribute loads and enhance a stable connection. In contrast to previous embodiments, only a primary set of retaining members may be required. When the extension assembly 130 is translated forward into the stowed position, the primary posts 128 may protrude to be received by the primary catches 126. In this way, the tailgate selectively retains to the extension sidewalls 140, 142 in both of the stowed and the extended positions.

Similar to other embodiments, at least one lock pin 152 may be used to hold the extension assembly 130 in a desired travel position. However the present embodiment may provide for additional or alternative locations of the lock pin 152. In at least one embodiment, the extension assembly 130 is held in a desired position when one or more lock pins 152 is inserted through holes in both of the upper portions of extension sidewalls 140, 142. The extension sidewalls 140, 142 may define stowed position lock holes 156 near a rear portion, and extended position lock holes 158 near a forward portion. Stop pins located near an upper portion of the extension sidewalls 140, 142 may replace, or be in addition to, stop pins inserted at the bed floor 116.

The alternate embodiment depicted in FIGS. 6 and 7 may also allow for additional or alternative locations for sliding tracks (not shown). Since the of extension sidewalls 140, 142 are fixed relative to a lower portion of unitary member 132, tracks may be disposed on one or both of the extension sidewalls 140, 142. Corresponding guide members may be located within each of the left side wall 118 and the right sidewall 120 to control the longitudinal travel of the extension assembly 130. Tracks on the side walls may replace, or be in addition to, tracks located at the bed floor 116.

Referring to FIG. 7, the cross section depicts one embodiment where a base portion of the unitary member 132 is beneath the bed floor. Also, the extension sidewalls 140, 142 are depicted to slide within an inner cavity of each of the pair of opposed sidewalls 118, 120 respectively. However, it is contemplated that it may be also be advantageous to arrange the unitary member to slidably travel on top the bed floor 16, and between the pair of opposed sidewalls 118, 120. In this way more traditional cargo bed architectures may be employed where the bed floor 116 can be bolted directly to a chassis frame. In such a configuration, sliding elements, such as the roller tracks discussed above for example, may be disposed between an upper surface of the bed floor 116 and a lower surface of the base portion of the unitary member 132.

While several embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle comprising:
a main cargo bed including a floor and a first pair of opposed sidewalls extending from the floor; and
an extension assembly having a base slidable relative to the main cargo bed, a second pair of opposed sidewalls rotatably extending from the base, and a tailgate pivotally coupled to the base, wherein the assembly is moveable to an extended position in which the tailgate latches to the second sidewalls when the tailgate is closed, and is moveable to a stowed position in which the tailgate latches to the first sidewalls when the tailgate is closed.

2. The vehicle of claim 1, wherein the base protrudes from the main cargo bed when in the extended position such that the second pair of opposed sidewalls and the tailgate define an extended bed rearward of the main cargo bed.

3. The vehicle of claim 2, further comprising a lock pin adapted to selectively fix the base in the stowed position and the extended position, respectively.

4. The vehicle of claim 2, wherein the second pair of opposed sidewalls is pivotally attached to the base, and are superposed over the base in the stowed position.

5. (canceled)

6. The vehicle of claim 1, wherein the tailgate further includes at least one primary retaining member adapted to engage a post disposed on the first pair of opposed sidewalls when the base is in the stowed position, and engage a post on the second pair of opposed sidewalls when the base is in the extended position.

7. The vehicle of claim 6, wherein the at least one primary retaining member includes a releasable latch.

8-9. (canceled)

10. A vehicle comprising:
a vehicle cargo bed including a floor, a first pair of opposed sidewalls extending from the floor; and
an extension assembly slidable with respect to the vehicle cargo bed and having a base, a second pair of opposed sidewalls rotatably attached to the base and capable of retaining to the first pair of opposed sidewalls, and a tailgate rotatably disposed on the base and cooperable with the second pair of opposed sidewalls,
wherein the extension assembly is movable to an extended position where the base is aligned with the floor forming an extended floor and the first pair of opposed sidewalls are aligned with the second pair of opposed sidewalls forming an extended pair of opposed sidewalls, and the tailgate latches to the extended pair of opposed sidewalls, and wherein the extension assembly is movable to a stowed position where the second pair of opposed sidewalls are superposed on the base and the extension assembly overlaps the floor, and the tailgate latches to the first pair of sidewalls.

11. The vehicle of claim 10, further comprising a first retaining member adapted to retain the second pair of opposed sidewalls to the first pair of opposed sidewalls in the extended position.

12. The vehicle of claim 10, further comprising a lock pin cooperating with the vehicle bed and the extension assembly to selectively fix the base in the stowed and the extended position, respectively.

13. The vehicle of claim 10, further comprising a second retaining member adapted to retain the tailgate to the second pair of opposed sidewalls in the extended position.

14. The vehicle of claim 13, wherein the second retaining member is a latch.

15. The vehicle of claim 10, wherein the tailgate is operable to engage the first pair of opposed sidewalls and the second pair of opposed sidewalls in the stowed position and extended position, respectively.

16. A cargo bed extension comprising:
a base operable to translate relative to, and stow against a vehicle cargo bed;
a pair of opposing secondary sidewalls extending from the base and adapted to latch to an opposing side of the cargo bed; and
a tailgate pivotally coupled to the base and capable of selectively latching to the cargo bed when the base is stowed and latching to the secondary sidewalls when the base is extended.

17. The cargo bed extension of claim 16, wherein the cargo bed extension defines a stowed position when the base and the pair of opposing sidewalls overlap the vehicle cargo bed, and defines an extended position when the base and the pair of opposing sidewalls overhang an edge of the vehicle cargo bed.

18. The cargo bed extension of claim 17, wherein the pair of opposing secondary sidewalls are operable to pivot and superpose over the base in the stowed position.

19. The cargo bed extension of claim 17, further comprising a lock pin cooperating with the vehicle cargo bed and the base, the lock pin operable to fix the base in the stowed position and the extended position, respectively.

20. The cargo bed extension of claim 16, further comprising a roller track allowing the base to slidably transition between a stowed position and an extended position.

21. The cargo bed extension of claim 16 wherein at least one of the secondary sidewalls further includes a post operable to latch with a retaining member disposed on the tailgate.
